(19) United States
(12) Patent Application Publication
(10) Pub. No.: US 2005/0000664 A1
(43) Pub. Date: Jan. 6, 2005

(54) Foldable automobile window shade with ultrasonically formed fold

(76) Inventor: Sunny E.L. Huang, Claremont, CA (US)

Correspondence Address: Paul M. Denk, Ste. 170, 763 S. New Ballas Road, St. Louis, MO, 63141, US

(21) Appl. No.: 10/876,186

(22) Filed: Jun. 24, 2004

Related U.S. Application Data
(60) Provisional application No. 60/480,799, filed on Jun. 24, 2003.

(51) Int. Cl. B60J 1/20

(52) U.S. Cl. 160/370.21

(57) ABSTRACT

A sunshade or sunscreen for an automobile includes fold lines. The sunshade is made from front and back layers and an intermediate layer. The front and back layers each have a reflective outer surface and an insulating inner surface. The intermediate layer is made from an insulating material, such as a form. To allow for folding of the sunshade, the shade is provided with fold lines which extend between opposed edges of the sunshade. The fold lines are formed by sonic (or ultrasonic) welding.

### CROSS-REFERENCE TO RELATED APPLICATIONS

This nonprovisional patent application claims priority to the provisional application having Ser. No. 60/480,799, which was filed on Jun. 23, 2003, which is related to application Ser. No. 10/307,482 filed Dec. 2, 2002, which is a continuation-in-part of application Ser. No. 10/116,946 filed Apr. 8, 2002, which is a continuation-in-part of application Ser. No. 09/766,557 filed Jan. 19, 2001, which is a continuation of application Ser. No. 09/417,277, filed Oct. 13, 1999, now U.S. Pat. No. 6,192,967, which claims benefit of provisional application Ser. No. 60/104,703, filed Oct. 19, 1998. Application Ser. No. 10.307,482, noted above, also is a continuation-in-part of 10/118,549 filed Apr. 8, 2002, which claims priority to provisional application Ser. No. 60/284,967 and a continuation-in-part of application Ser. No. 09/766,557 filed Jan. 19, 2001, which is a continuation of application Ser. No. 09/417,277, filed Oct. 13, 1999, now U.S. Pat. No. 6,192,967, which claims benefit of provisional application Ser. No. 60/104,703, filed Oct. 19, 1998. All of the above noted applications and patents are incorporated herein by reference.

### BACKGROUND OF THE INVENTION

The present invention relates generally to collapsible shades designed to for fitment in a window, such as of an automobile, so as to protect the interior by preventing the entrance of damaging sun rays and the generation of damaging heat, and in particular, to an improved method of forming the shades to make the shades easier to fold.

Numerous styles of window screens and shades adapted for use in automobiles have long been available in the art. For example, U.S. Pat. No. 5,035,460 for an automobile window protector, which is incorporated herein by reference, shows the fabrication of such a screen, made of flexible material, and which could be applied to either the interior and exterior of the window of an automobile. In addition, U.S. Pat. No. B1 5,024,262, which is incorporated herein by reference, shows a compactly foldable automobile sunshade, which provides for inherent resiliency, at least around its perimeter loop, to hold the shade in an opened configuration, and to provide sunlight protection at the vicinity of the automobile window, but which is capable of significant reduction in size through the folding of the frame into a more compact arrangement for suitable for storage.

During use, an automobile windows shade is typically installed adjacent an automobile window, blocking incoming sunlight or providing interior privacy. When not in use, the shade is generally collapsed. Many of the currently available shades are collapsed by folding the shade. Typically, the shade is prefolded at the manufacturing facility to impart fold lines to the shade to enable the user to easily fold the shade. To make the folds in the shade requires specialized equipment which will fold an unfolded shade in order to form the fold lines.

### BRIEF SUMMARY OF THE INVENTION

A sunshade or sunscreen for an automobile includes fold lines. The sunshade is made from front and back layers and an intermediate layer. The front and back layers each have a reflective outer surface and an insulating inner surface. The intermediate layer is made from an insulating material, such as a form. To allow for folding of the sunshade, the shade is provided with fold lines which extend between opposed edges of the sunshade. The fold lines are formed by sonic (or ultrasonic) welding.

### BRIEF DESCRIPTION OF THE DRAWINGS

FIG. 1 is a plan view of a window shade of the present invention;

FIG. 2 is an enlarged cross-sectional view of the window shade taken along line 2-2 of FIG. 1;

FIG. 3 is an enlarged cross-sectional view of the window shade taken along line 3-3 of FIG. 1; and

FIG. 4 is a perspective view of the window shade mounted in a vehicle.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

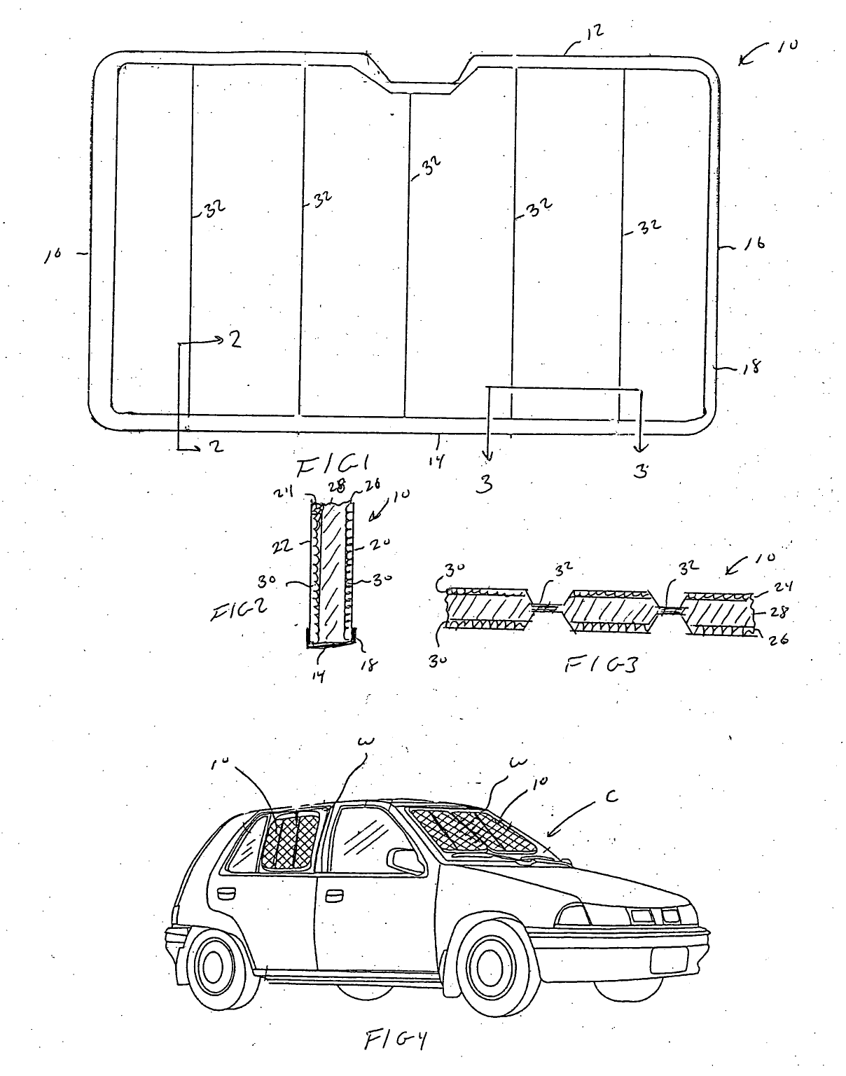

An automobile sunshade or screen 10 is shown in FIGS. 1 and 2. The sunshade 10 is sized and shaped to fit in a window, such as a windshield or back window of a car. The sunshade could also be sized and shaped to fit in a side window of a car. The sunshade 10 includes a top edge 12, a bottom edge 14, and side edges 16. The sunshade can be provided with a finishing strip 18 which extends around the periphery of the sunshade and covers the edges of the sunshade. The strip 18 can, for example, be made from cloth. The strip is sufficiently wide to overlap both the front and back surface 20 and 22, respectively of the sunshade, and is adhered to the front and back surfaces, such as by sewing, gluing, stapling, or any other conventional method.

The sunshade 10, as best seen in FIG. 2, has a front layer 24, a back layer 26, and an intermediate layer 28. At least one of, and preferably both of, the front and back layers 24 and 26 are made from a material which has a reflective outer surface. The inner surface of the front and back layers can be insulated, and can be provided with air filled pockets 30. The outer reflective surfaces of the front and back layers define the front and back surfaces 20 and 22 of the sunshade. The intermediate layer 28 is preferably made from a pliable insulating material, such as an expanded foam, which can be a closed cell foam. To facilitate folding of the sunshade, the sun shade is provided with fold lines 32 which extend from one edge to the opposite edge—preferably between the top and bottom edges 12 and 14. The fold lines 32 are preferably formed by ultrasonic welding. As seen in FIG. 3, the insulating intermediate layer 28 is compressed (and melted) by the ultrasonic welding process, to bring the front and back layers closer together. The ultrasonically welding process thereby forms permanent fold lines in the sunshade.

The ultrasonic welding process can be performed using any conventional ultrasonic welding equipment. The ultrasonic welding equipment can have a single ultrasonic welding tip which is moved between the top and bottom edges to form the fold lines, and which is moved across the sunshade by appropriate indexing equipment to form each fold line in the shade. In this case, the formed sunshade would be positioned on a table of the ultrasonic welding equipment, the welding tip would be brought down into operative contact with the sunshade, the welding tip would be activated, and then the welding tip would be moved between the top and bottom edges (or between the side edges) of the sunshade to form a first fold line. The tip would then be raised and the indexing equipment would move the tip perpendicularly to the fold line just formed. The tip would then be lowered, and a second fold line would then be formed. This process would be repeated until a predetermined number of fold lines are formed in the sunshade. Alternatively, the ultrasonic welding equipment can include multiple ultrasonic welding tips which simultaneously form each fold line. As can be appreciated, using multiple welding tips, the fold lines can be formed more quickly. However, the equipment having a welding tip movable across the shade allows for more flexibility in that different size shades, which require differing numbers of fold lines, can be accommodated, by programming the machine.

FIG. 4 shows the sunshade 10 mounted in the window W of a car C. When installed in the car window, the shade is positioned such that reflective outer surface is substantially adjacent the window. The reflective surface of the shade will then reflect the light energy back out of the car, to reduce heating of the interior of the car. Additionally, the insulating properties of the inner surfaces of the front and back layers 24, 26 and of the intermediate layer 28 will reduce the amount of heat which radiates through the shade, to again, reduce the amount of heat energy which enters the car. Because the intermediate layer is, in effect, melted by the sonic welding process, the intermediate layer is denser along the fold lines 32 than throughout the rest of the sunshade. Hence, the insulating properties of the intermediate layer may not be quite as good as throughout the rest of the shade. However, the small portion of the intermediate layer which is affected by the welding process will not substantially effect the overall insulating capabilities of the sunshade.

As various changes could be made in the above constructions without departing from the scope of the invention, it is intended that all matter contained in the above description or shown in the accompanying drawings shall be interpreted as illustrative and not in a limiting sense. For example, the insulating inner surface of the inner and outer layers 24 and 26 of the shade could be omitted. This example is merely illustrative.

1. A sunscreen for use in conjunction with an automobile window and which is formed having front and back layers, and an intermediate layer therebetween, at least the front layer having reflective properties to reflect sunlight from the automobile to reduce the generation of heat within the automobile interior, said intermediate layer formed from an insulating material, and arranged laminarly with the front and back layers of the formed sunscreen, a series of fold lines formed within the sunscreen to facilitate its folding into a reduced size, said fold lines being formed by ultrasonic welding.

2. The sunscreen of claim 1 wherein the front and back layers may be formed of one of a cloth, or polymer fabric, with at least the outer layer having a surface of reflective material, and a finishing strip provided around the periphery of the sunshade and extending slightly inwardly of the front and back layers, to provide a finishing strip around the periphery of the formed sunscreen.

3. The sunscreen of claim 2 wherein the fold lines are arranged parallel to each other.

4. The sunscreen of claim 2 wherein the reflective coating is formed of a metallic material.

5. The sunscreen of claim 2 wherein the reflective coating is formed of a metallic polymer.

6. The sunscreen of claim 2 wherein the intermediate insulating layer being formed of one of expanded foam, a closed cell foam, or a polymer bubble configured material.

7. The sunscreen of claim 6 wherein the insulating layer comprises two or more layers of insulating material.

8. The sunscreen of claim 2 wherein both the front and back layers are formed having a metallic reflective coating.

9. The sunscreen of claim 3 wherein the fold lines provide for a reduction in the size of the sunscreen for storage.

10. The sunscreen of claim 2 wherein said sunscreen when applied, fits within the structure of the interior of the automobile window.
